(19) United States
(12) Patent Application Publication
(10) Pub. No.: US 2016/0144902 A1
(43) Pub. Date: May 26, 2016

(54) Vehicle Fender Flare With An Integral Mud Flap

(71) Applicant: Air Design SA de CV, Tlalnepantla (MX)

(72) Inventors: Carlos Avalos Sartorio, Tlalnepantla (MX); Miguel Avalos Sartorio, Tlalnepantla (MX)

(21) Appl. No.: 14/950,993

(22) Filed: Nov. 24, 2015

Related U.S. Application Data
(60) Provisional application No. 62/123,665, filed on Nov. 24, 2014.

(51) Int. Cl. B62D 25/18

(52) U.S. Cl. CPC B62D 25/18

(57) ABSTRACT

A fender flare for use on automobiles includes an integral mud flap. The fender flare includes a fender flare body configured to mount against a laterally outwardly facing surface of a vehicle fender, and a mud flap portion disposed on a terminal end of the fender flare body. The fender flare may further include a plurality of apertures formed in the fender flare body. Each aperture has a central axis extending generally in a lateral direction in relation of a vehicle in an installed condition whereby the fender flare may be mounted on the corresponding laterally outwardly-facing surface of a vehicle fender.

### CROSS-REFERENCE

This application claims the benefit of priority to U.S. Provisional Patent Application Ser. No. 62/123,665 filed Nov. 24, 2014 (pending), the disclosure of which is expressly incorporated by reference herein in its entirety.

### TECHNICAL FIELD

This present invention relates generally to automobile exterior ornamentation and, more particularly, to automotive fender flares having an integrated mud flap.

### BACKGROUND

Fender flares are generally known in the art of automotive accessories and provide various aesthetic and functional benefits to vehicles to which they are mounted. Not only do fender flares provide an improved aesthetic appearance, but they also help to prevent or reduce spraying of water, mud, ice, and other debris which may be thrown from the tires of a vehicle and which would otherwise accumulate on the vehicle body. Fender flares may be provided as an original equipment manufacturer (OEM) component of the vehicle, or may be installed by dealerships or vehicle owners using fender flares available from aftermarket suppliers.

Another accessory that helps to prevent or reduce spraying of water, mud, ice, and other debris which may be thrown from the tires onto the body of a vehicle are mud flaps. Mud flaps may be provided by OEMs as a component of the vehicle fender, or may be installed on vehicles by dealerships or owners. If vehicle owners desire to have both fender flares and mud flaps installed on their vehicles, installation of these separate accessories generally requires multiple installation processes required for each component. Moreover, fender flares and mud flaps that may be available from different suppliers may not suitably mate with one another to provide clean lines and a visually appealing appearance. A need exists for a fender flare that includes an integral mud flap.

It is an object of the present invention to provide a fender flare that offers mud flap as an integral feature, without requiring the installation of a separate mud flap, thereby providing a more integrated design consistent with the style of the vehicle to which it is installed.

### SUMMARY

The present invention provides a fender flare for use on automobiles and which has an integral mud flap. In one aspect, a fender flare in accordance with the principles of the present disclosure includes a fender flare body configured to mount against a laterally outwardly facing surface of a vehicle fender. A plurality of apertures are formed in the body, and each aperture has a central axis extending substantially laterally relative to the vehicle in an installed condition of the fender flare on vehicle. The fender flare further includes a mud flap portion disposed on a terminal end of the fender flare body.

In another aspect, the plurality of apertures are located in respective recesses formed in the fender flare body. The apertures facilitate mounted the fender flare on the corresponding laterally outwardly-facing surface of a vehicle fender.

While the invention will be described in connection with certain embodiments, it will be understood that the invention is not limited to these embodiments. On the contrary, the invention includes all alternatives, modifications and equivalents as may be included within the spirit and scope of the present invention.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIGS. 1A and 1B depict exemplary fender flares in accordance with the principles of the present disclosure mount on a vehicle.

FIG. 2 is a perspective view of the front fender flare of FIG. 1.

FIG. 3 is another perspective view of the fender flare of FIG. 1.

FIG. 4 is a side view of the fender flare of FIG. 2.

FIG. 5 is perspective view of the fender flare of FIG. 2, viewed from a different angle.

FIG. 6 is a top plan view of the exemplary fender flare of FIGS. 1-5.

FIG. 7 is a bottom view of the exemplary fender flare of FIGS. 1-5.

FIG. 8 is a right side elevation view of the exemplary fender flare of FIGS. 1-5.

FIG. 9 is a left side elevation view of the exemplary fender flare of FIGS. 1-5.

### DETAILED DESCRIPTION

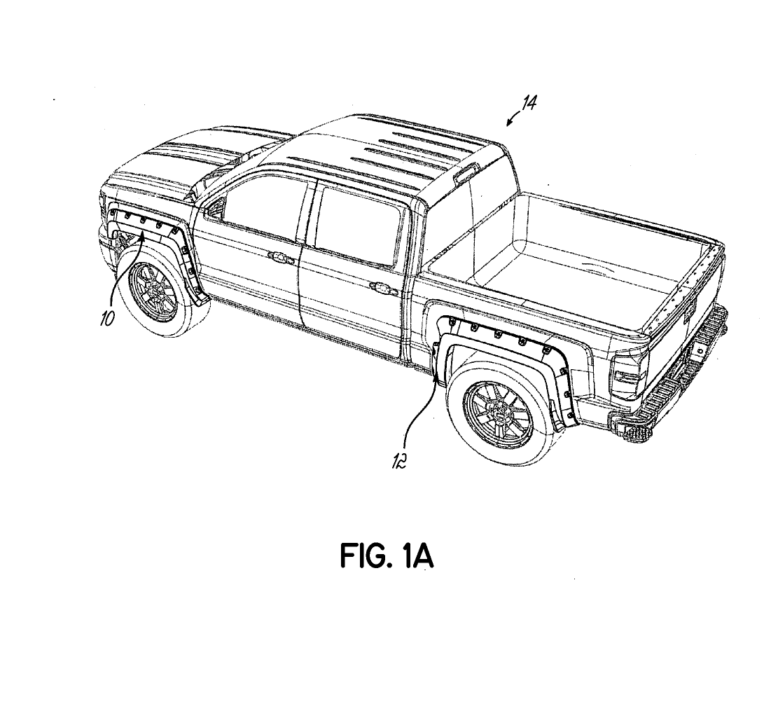

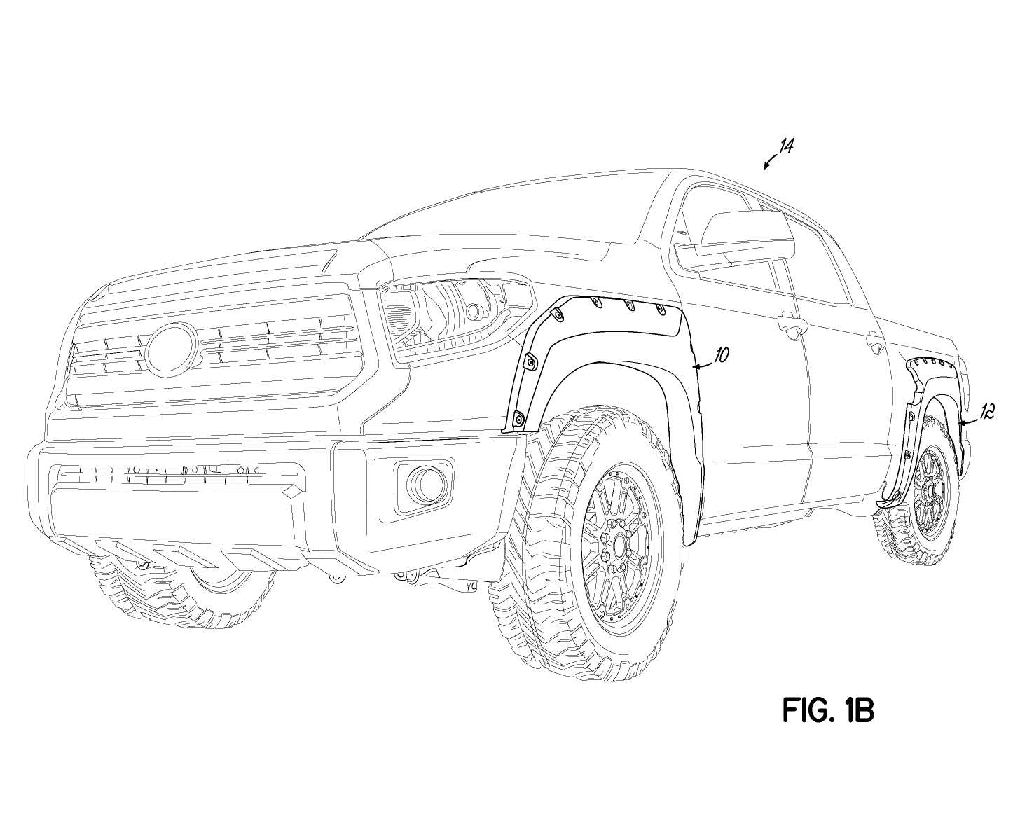

FIGS. 1A and 1B illustrate exemplary front and rear fender flares 10, 12 in accordance with the principles of the present disclosure shown in an installed condition on a vehicle 14. The fender flares 10, 12 may be coupled with the fender portions of the vehicle body and generally surround at least corresponding portions of the wheel wells of the respective fenders to which they are attached.

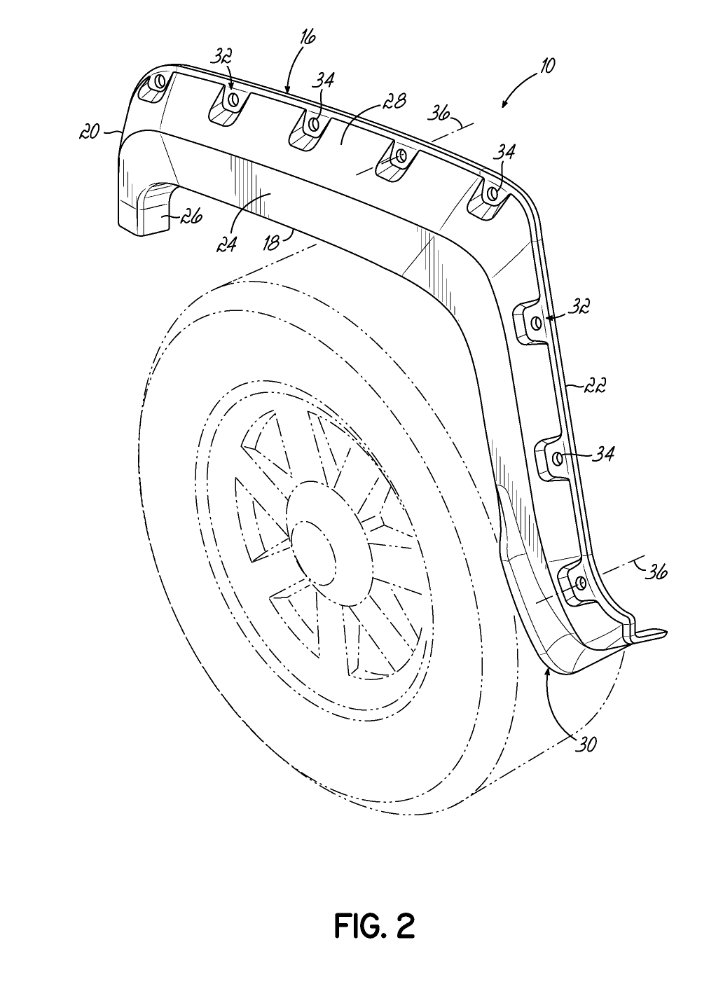

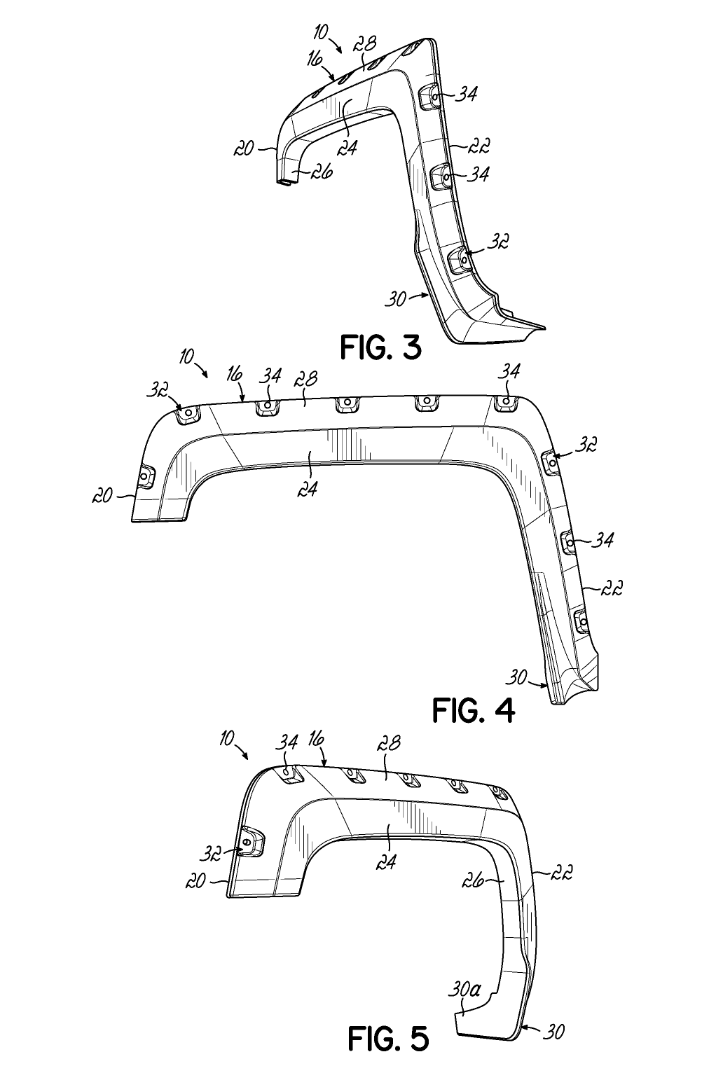

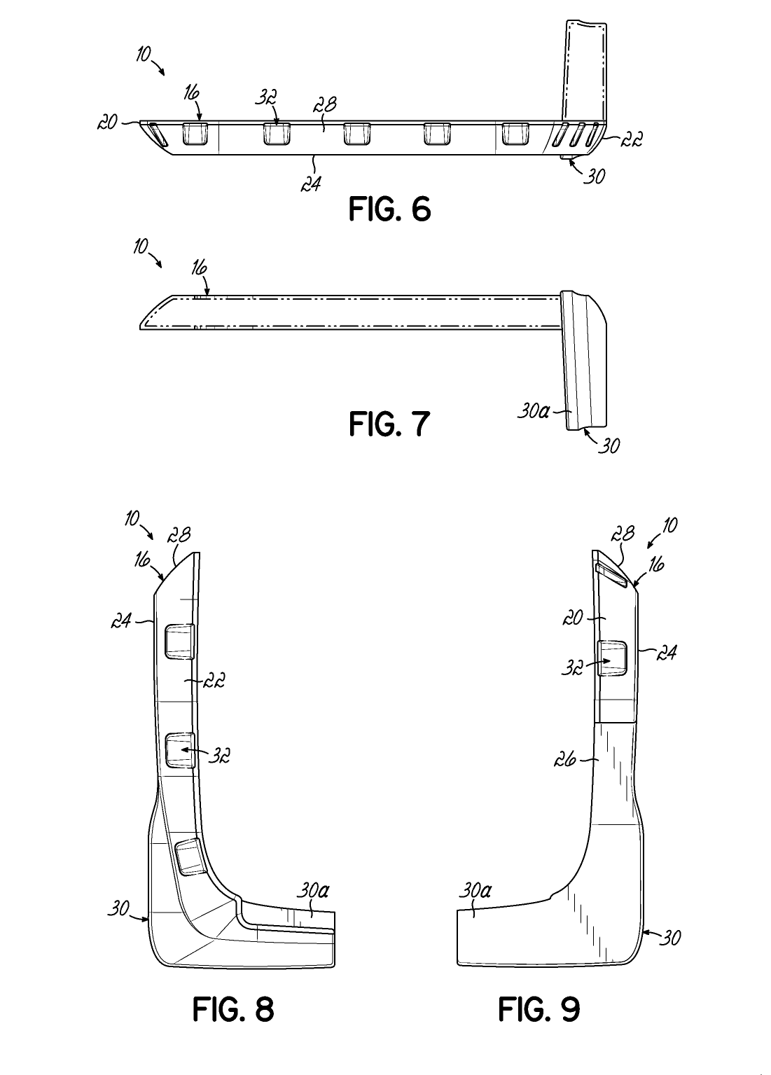

With continued reference to FIGS. 1A and 1B, and referring further to FIGS. 2-5, the exemplary front fender flare 10 will be described in more detail. In this embodiment, the fender flare 10 includes a body 16 having a generally elongate central portion 18 and first and second arm portions 20, 22 disposed at opposite ends of the central portion 18 to define a generally arcuate shape configured to correspond with the opening of the respective wheel well of the vehicle body to which it will be installed. The central portion 18 and the first and second arm portions 20, 22 of the fender flare body 18 define a generally outwardly-facing side surface 24 when viewed in an orientation as would be installed on the vehicle, and a corresponding lower surface 26 adjacent the side surface 24. The lower surface 26 generally faces the area corresponding to the opening of the wheel well on the vehicle. The fender flare body 16 further includes an upper beveled surface 28 disposed generally opposite the lower surface 26 and defining an acute angle relative to the plane of the side surface 24 of the fender flare body 16.

The fender flare 10 further includes a mud flap portion 30 disposed at a distal end of the second arm portion 22 of the body 16. The mud flap portion 30 is integrally formed with the rest of the fender flare body 16, and at least a part 30a of the mud flap portion 30 extends in a direction generally opposite the side surface 24 of the body (best seen in FIG. 5) to expand across a space that corresponds to area positioned behind a wheel of the vehicle in an installed condition of the fender flare 10.

The fender flare 10 further includes a plurality of recesses 32 disposed generally on the upper beveled surface 28 of the central body portion 16 and the first and second arm portions 20, 22 of the fender flare 10. The recesses 32 define lands that facilitate mounting the fender flare 10 to the vehicle body using appropriate fasteners (not shown). To this end, the fender flare 10 further includes a plurality of apertures 34, wherein each aperture is located within a respective recess 32. Central axes 36 of the respective apertures 34 extend in a substantially lateral direction in relation to the vehicle in installed condition. Accordingly, the fender flare 10 may be positioned against a laterally outwardly facing surface of a corresponding vehicle fender and mounted thereto by appropriate fasteners positioned to align with the apertures 34 in the fender flare 10.

A fender flare 10 in accordance with the present disclosure may be formed by injection molding, vacuum forming, or various other manufacturing processes suitable for forming the integral fender flare and mud flap shown as described herein.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. A vehicle fender flare, comprising:
a fender flare body configured to mount against a laterally outwardly facing surface of a vehicle fender;
a plurality of apertures in the body, each aperture having a central axis extending substantially laterally relative to the vehicle in an installed condition; and
a mud flap portion disposed on a terminal end of the fender flare body.

2. The vehicle fender flare of claim 1, wherein the fender flare body comprises:
a generally elongate central body portion; and
at least one arm portion extending from an end of the central body portion.

3. The vehicle fender flare of claim 2, wherein the fender flare body comprises first and second arm portions extending from opposite ends of the central body portion.

4. The vehicle fender flare of claim 2, wherein the mud flap is located proximate a distal end of the at least one arm portion.

5. The vehicle fender flare of claim 1, further comprising:
a plurality of apertures in the fender flare body, each aperture having a central axis extending generally in a lateral direction in relation of a vehicle in an installed condition of the fender flare.
